(19) United States
(12) Patent Application Publication
(10) Pub. No.: US 2025/0067890 A1
(43) Pub. Date: Feb. 27, 2025

(54) SUBSEA OPTICAL AMPLIFICATION AND CIRCULATOR FOR OPTICAL SENSING

(71) Applicant: Schlumberger Technology Corporation, Sugar Land, TX (US)

(72) Inventor: Paul Stopford, Clamart (FR)

(21) Appl. No.: 18/725,223

(22) PCT Filed: May 11, 2023
(86) PCT No.: PCT/US2023/021810

§ 371 Date: Jun. 28, 2024

Related U.S. Application Data
(60) Provisional application No. 63/364,645, filed on May 13, 2022.

(51) Int. Cl. G01V 1/44; G01V 1/22

(52) U.S. Cl. CPC G01V 1/44; G01V 1/226; G01V 2210/123; G01V 2210/1299; G01V 2210/1429

(57) ABSTRACT

A technique facilitates improved transmission of signals in subsea measurement operations. The improved transmission may involve use of various signal amplifiers. According to an embodiment, a distributed measurement system comprises a surface system coupled with a subsea system via an umbilical. The surface system may comprise a distributed interrogator combined with a surface circulator and pump module. Additionally, the subsea system may comprise a remote circulator module having, for example, at least one remote optical amplifier and which may be coupled with a distributed sensor. The umbilical may utilize an outgoing optical fiber and a returning optical fiber.

### CROSS-REFERENCE TO RELATED APPLICATION

The present document is based on and claims priority to U.S. Provisional Application Ser. No. 63/364,645, filed May 13, 2022, which is incorporated herein by reference in its entirety.

### BACKGROUND

Hydrocarbon fluids such as oil and natural gas are obtained from a subterranean geologic formation via a well. Some wells are located subsea and comprise at least one wellbore drilled at a substantial distance beneath a surface of the sea. Various types of sensors, including distributed sensors, may be used to monitor parameters related to development and operation of the subsea well. Optical fibers may be used to carry signals between the surface and sensors located subsea, e.g. in the subsea wellbore. However, the distance between the subsea sensors and the surface can be substantial and transmitting signals over this distance can lead to various types of signal losses and other problems which negatively impact monitoring of the desired parameters.

### SUMMARY

In general, a system and methodology are provided for facilitating improved transmission of signals in subsea measurement operations. The improved transmission may involve use of various signal amplifiers. According to an embodiment, a distributed measurement system comprises a surface system coupled with a subsea system via an umbilical. The surface system may comprise a distributed interrogator combined with a surface circulator and pump module. Additionally, the subsea system may comprise a remote circulator module having, for example, at least one remote optical amplifier and which may be coupled with a distributed sensor. The umbilical may utilize an outgoing optical fiber and a returning optical fiber.

However, many modifications are possible without materially departing from the teachings of this disclosure. Accordingly, such modifications are intended to be included within the scope of this disclosure as defined in the claims.

### BRIEF DESCRIPTION OF THE DRAWINGS

Certain embodiments of the disclosure will hereafter be described with reference to the accompanying drawings, wherein like reference numerals denote like elements. It should be understood, however, that the accompanying figures illustrate the various implementations described herein and are not meant to limit the scope of various technologies described herein, and:

FIG. 1 is an illustration of an example of a distributed measurement system which may be used in a subsea application, according to an embodiment of the disclosure;

FIG. 2 is an illustration of another example of a distributed measurement system which may be used in a subsea application, according to an embodiment of the disclosure;

FIG. 3 is an illustration of examples of subsea components which may be utilized in the distributed measurement system, according to an embodiment of the disclosure;

FIG. 4 is an illustration of an example of a remote optical amplification component which may be used subsea in the distributed measurement system, according to an embodiment of the disclosure;

FIG. 5 is an optical schematic illustrating an example of a subsea system utilizing remote optical amplification, according to an embodiment of the disclosure; and

FIG. 6 is a graphical representation of an example of distributed acoustic sensing noise levels as a function of increasing umbilical system loss, according to an embodiment of the disclosure.

### DETAILED DESCRIPTION

In the following description, numerous details are set forth to provide an understanding of some embodiments of the present disclosure. It is to be understood that the following disclosure provides many different embodiments, or examples, for implementing different features of various embodiments. Specific examples of components and arrangements are described below to simplify the disclosure. These are, of course, merely examples and are not intended to be limiting. However, it will be understood those of ordinary skill in the art that the system and/or methodology may be practiced without these details and that numerous variations or modifications from the described embodiments may be possible. This description is not to be taken in a limiting sense, but rather for the purpose of describing general principles of the implementations. The scope of the described implementations should be ascertained with reference to the issued claims.

As used herein, the terms “connect”, “connection”, “connected”, “in connection with”, and “connecting” are used to mean “in direct connection with” or “in connection with via one or more elements”; and the term “set” is used to mean “one element” or “more than one element”. Further, the terms “couple”, “coupling”, “coupled”, “coupled together”, and “coupled with” are used to mean “directly coupled together” or “coupled together via one or more elements”. As used herein, the terms “up” and “down”; “upper” and “lower”; “top” and “bottom”; and other like terms indicating relative positions to a given point or element are utilized to more clearly describe some elements. Commonly, these terms relate to a reference point at the surface from which drilling operations are initiated as being the top point and the total depth being the lowest point, wherein the well (e.g., wellbore, borehole) is vertical, horizontal or slanted relative to the surface.

The disclosure herein generally involves a system and methodology for facilitating improved transmission of signals in subsea measurement operations. The improved transmission may involve use of various signal amplifiers which reduce signal losses with respect to fiber optical sensing in, for example, oil and gas wells and especially those in a subsea setting. The improved transmission also facilitates sensing in other applications, such as geothermal or carbon capture, usage and storage (CCUS) applications. The signal amplification technique may utilize a remote optical amplifier (ROA) which can be active, passive, or hybrid. An example of one type of an ROA technique is disclosed in U.S. Pat. No. 7,595,865, the entire content of which is hereby incorporated by reference into this document.

According to an embodiment, a distributed measurement system comprises a surface system coupled with a subsea system via an umbilical. The surface system may comprise a distributed interrogator combined with a surface circulator and pump module. Additionally, the subsea system may comprise a remote circulator module having, for example, at least one remote optical amplifier and which may be coupled with a distributed sensor. The umbilical may utilize an outgoing optical fiber and a returning optical fiber.

This type of fiber-optic distributed measurement system is well-suited for use in oil and gas wells especially in the subsea setting as well as geothermal or CCUS applications. In various embodiments, subsea wells may be equipped with moderate step-out umbilical distances while retaining interrogation equipment on the surface. In some configurations, a subsea system is employed which comprises at least one ROA, e.g. a plurality of ROAs, packaged within a subsea deployable fiber optic line lead.

The types of distributed measurement systems described herein facilitate use of distributed sensing technologies in applications such as flow and production surveillance and 4D seismic surveys for subsea wells or other types of wells. It should be noted that marinization of optical interrogators can be challenging in terms of size, power requirements, and data distribution especially in the case of distributed acoustic sensing (DAS). Accordingly, the architectures of embodiments described herein retain the siting of at least portions of monitoring equipment at the surface, e.g. on a platform, a floating production storage and offloading (FPSO) system, or a control room on shore.

This approach can create substantial distance between the monitoring equipment and the well being monitored such that optical signals pass through, for example, several kilometers of fiber cable equipped umbilical. An additional consideration is the loss related to connections, e.g. wet mate and dry mate connections, at umbilical termination assemblies, distribution assemblies and units, manifolds, and at wellhead fiber-optic feedthrough systems. However, the signal amplification techniques described herein enable a robust, dependable, subsea distributed measurement system.

According to an embodiment, a distributed measurement system is constructed to overcome substantial optical signal losses (e.g. often greater than the normal equipment loss budget), and to overcome a time-of-flight mandating a slower interrogator “ping rate” (normally a wait time is required for backscatter to return before firing another pulse). For example, the distributed measurement system may utilize a subsea distributed fiber optic sensing amplification system able to provide amplification of an optical output pulse and an optical backscatter to overcome cumulative losses. Some embodiments may utilize optical circulators to split the outgoing optical pulse and incoming backscatter onto two separate fibers. As a result, the ping rate is no longer limited by the entire system length but instead only by the fiber length in the well as in normal situations. This enables use of a higher ping rate to help detect high-frequency events and/or to increase the signal-to-noise ratio of the optical signal.

In the context of a subsea environment, the distributed measurement system may be configured to provide a passive solution. This type of passive solution refers to use of an unpowered, remote optical amplifier. According to an embodiment, the distributed measurement system comprises an instrument, e.g. an instrument sited with a distributed fiber optics sensing interrogator. The instrument provides optical pump power used by a remote optical amplifier, or a plurality of remote optical amplifiers, which can be integrated/packaged into, for example, a fiber optic flying lead which is subsea deployable.

Depending on the parameters of a given application, embodiments of the amplification technology also may be applicable to quasi-distributed fiber optic sensors, e.g. arrays of pressure sensors, strain sensors, temperature sensors, and/or accelerometers. The amplification technology also may be employed with respect to deployed point sensors, e.g. pressure sensors, strain sensors, temperature sensors, or accelerometers. By way of example, the amplification technology may be modular and may use building blocks to create a passive system. However, such building blocks also may be used to construct an active system in which, for example, pump lasers are co-located with optical amplifiers. Such an active system can be packaged in a subsea pod which would need power and communication capabilities but would be able to deliver substantially higher amplifier gain allowing long reach step-out sensing capability.

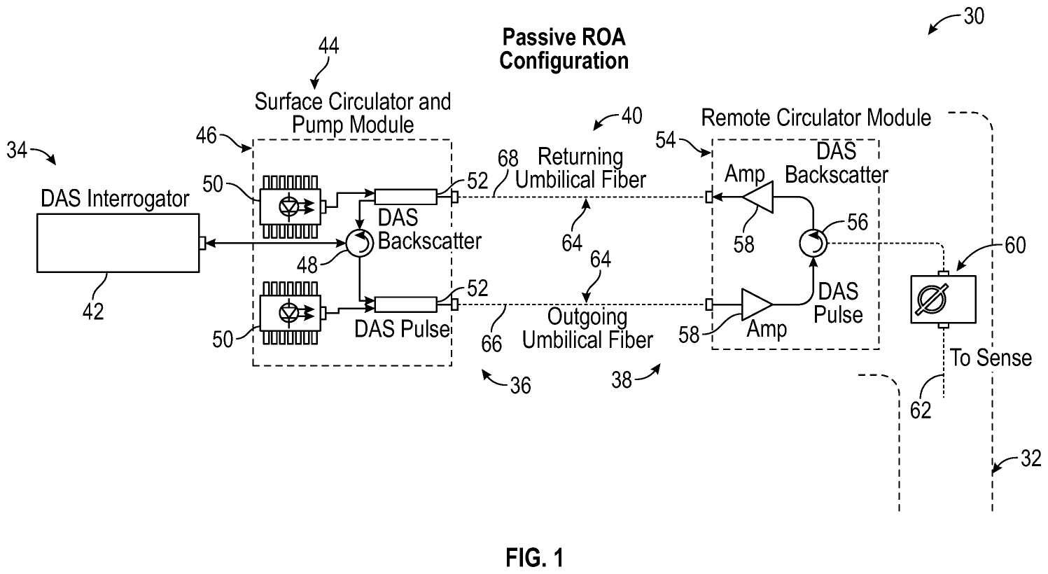

Referring generally to FIG. 1, a system 30 is illustrated for use in a subsea application and at least a portion of the system 30 may be deployed within a subsea borehole 32, e.g. a wellbore. In this example, the system 30 comprises a distributed measurement system 34 having a surface system 36 coupled with a subsea system 38 via an umbilical 40.

The surface system 36 comprises components located at the surface, e.g. on a platform, a FPSO, or in a control room on shore. The subsea system 38 is located at or along, for example, the wellbore 32 or other type of borehole. By way of example, the surface system 36 may comprise a distributed sensor system interrogator 42 providing the desired optical signals. In the illustrated embodiment, the distributed sensor system interrogator 42 is in the form of a distributed acoustic sensing interrogator.

Additionally, the surface system 36 may comprise a surface pump module 44 coupled with the interrogator 42 and the umbilical 40. By way of example, the surface pump module 44 may be in the form of a surface circulator and pump module 46 which comprises optical signal handling and processing components, such as a circulator 48, a plurality of optical pickup units 50, and a plurality of wavelength division multiplexers 52.

In this example, the subsea system 38 comprises a remote circulator module 54. The remote circulator module 54 may comprise various components, such as a subsea circulator 56 which works in cooperation with at least one remote optical amplifier (ROA) 58. In the specific embodiment illustrated, the remote circulator module 54 comprises a plurality, e.g. two, of the ROAs 58.

Additionally, the remote circulator module 54 is coupled with a distributed sensor system 60 having a distributed sensor 62. In the example illustrated, the distributed sensor 62 is in the form of a distributed acoustic sensor (DAS). Furthermore, the umbilical 40 may have a variety of configurations and arrangements of optical fibers 64 located in, for example, an optical fiber cable. In the example illustrated, the umbilical 40 comprises an outgoing optical fiber 66 and a returning optical fiber 68.

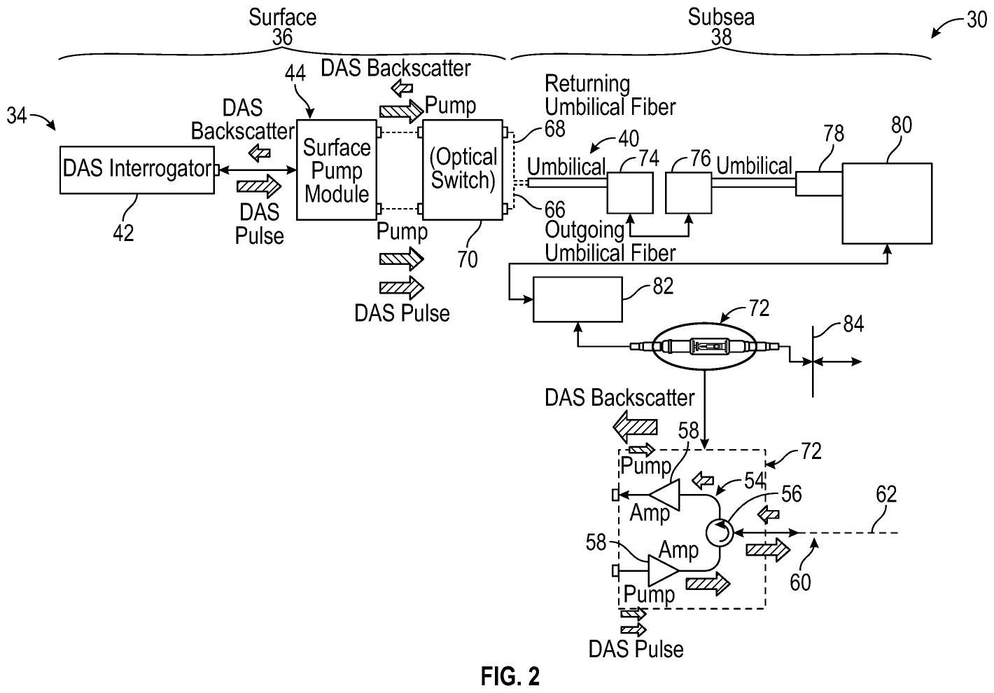

Referring generally to FIG. 2, another example of the distributed measurement system 34 is illustrated. In this embodiment, the surface system 36 comprises surface pump module 44 which may be similar to surface circulator and pump module 46 described with reference to FIG. 1. The surface pump module is coupled with an optical switch 70 which, in turn, is connected with umbilical 40.

In this embodiment, the subsea system 38 comprises a fiber optic flying lead 72 which may be coupled with a suitable sensor or sensors such as distributed sensor 62. The fiber optic flying lead 72 may incorporate various optical components such as subsea circulator 56 and at least one remote optical amplifier 58, e.g. a plurality of ROAs 58. In the illustrated example, two remote optical amplifiers 58 are employed with one remote optical amplifier 58 on the outgoing optical fiber side of circulator 56 and one remote optical amplifier 58 on the returning optical fiber side of circulator 56.

Furthermore, the umbilical 40 may have various sections, features, and components. For example, the umbilical 40 may comprise a subsea distribution assembly 74 coupled with an umbilical termination assembly 76 of another section of the umbilical 40. Other component examples include an additional termination assembly 78 which connects a section of the umbilical 40 with a manifold 80. In this embodiment, the manifold 80 may be coupled with the fiber optic flying lead 72 via a suitable distribution unit 82. It should be noted that various alternate and/or additional features and components may be incorporated into the overall system. One example of an additional component is a remotely operated vehicle (ROV) panel 84 enabling, for example, communication with the fiber optic flying lead 72.

According to an operational example, a DAS pulse of light is generated by the DAS interrogator 42 at a given wavelength. In this example, the distributed sensor system 60 utilizes or is connected to a single optical fiber. The amorphous nature of the optical fiber causes light to scatter along the fiber, some of which is captured as backscatter and this backscatter is detected, processed, and converted to a measurement.

Specifically, the outgoing pulse of light may be transmitted through the surface pump module 44 which splits the outgoing pulse and incoming backscatter into two separate optical fibers. The optical pulse is combined with high power “pump” light at a different wavelength onto the same outgoing fiber (outgoing optical fiber 66). The high power pump light of the different wavelength is used to provide energy to the ROAs 58. In some embodiments, the high power pump light at the different wavelength also is launched into the returning backscatter fiber 68 so that it is contra-propagating to the incoming backscatter.

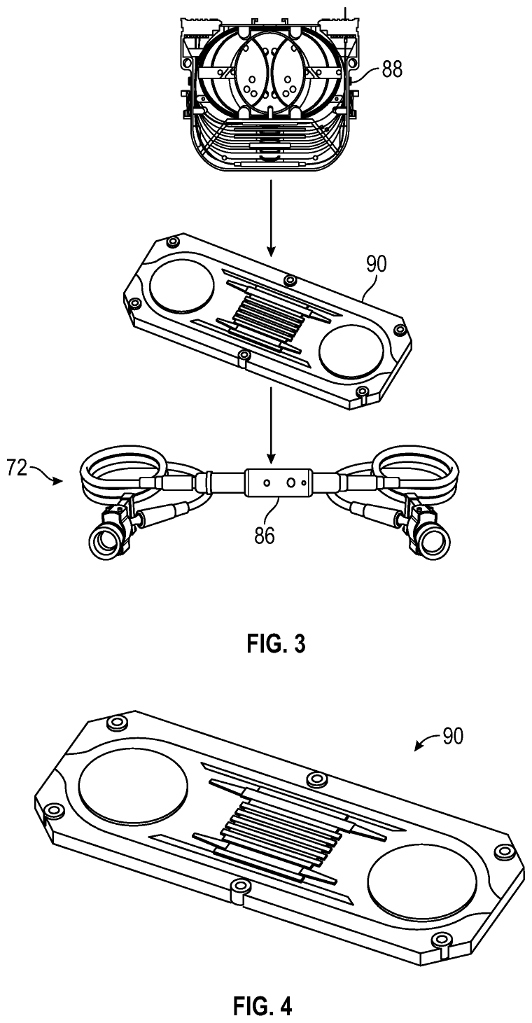

The two fibers 66, 68 enter umbilical 40 and extend to the subsea system 38 and ultimately to the fiber optic flying lead 72 and/or ROV panel 84. By way of example, the subsea circulator 56 and the amplifiers 58 may be integrated into a canister 86, e.g. a 1 atm canister, of the fiber optic flying lead 72 (see FIG. 3). The pump light is absorbed by the remote optical amplifiers 58 and provides a stimulated emission when the weaker DAS pulse arrives. This has the effect of amplifying the DAS light pulse and overcoming system losses. The energy of the pump light is transferred to the DAS light pulse.

Consequently, the now higher energy DAS light pulse travels through various optics to the downhole optical fiber of, for example, distributed sensor 62 where light will be scattered along this optical fiber. Some of the scatter is captured in the rear facing direction and is called backscatter. The backscatter returns uphole and, due to the circulator 56 in the fiber optic flying lead 72, is routed to the returning optical fiber 68. After passing through the circulator 56, the backscatter traverses through the second remote optical amplifier 58 which provides desired amplification. This second remote optical amplifier 58 is energized by the pump light arriving from topside along the returning optical fiber 68. At this stage, the backscatter is relatively large and traverses the subsea system 38 (including umbilical 40) while reducing in intensity. The backscatter is further routed through the surface pump module 44, through surface circulator 48, and back to the DAS interrogator 42. The backscatter is now at a normal level to be detected, processed, and converted to a measurement.

In FIG. 3, a physical example of the fiber optic flying lead 72 is illustrated as including the canister 86. The canister 86 houses and protects various components, such as remote optical amplifier optics 88 and remote optical amplifiers 58. As further illustrated in FIG. 4, the remote optical amplifiers 58 may be incorporated into a multi-channel remote optical amplifier stack located in a suitable remote optical amplifier cassette 90. By way of example, each remote optical amplifier 58 may be arranged on a tray, card, or cassette which can be stacked in the interior space within canister 86.

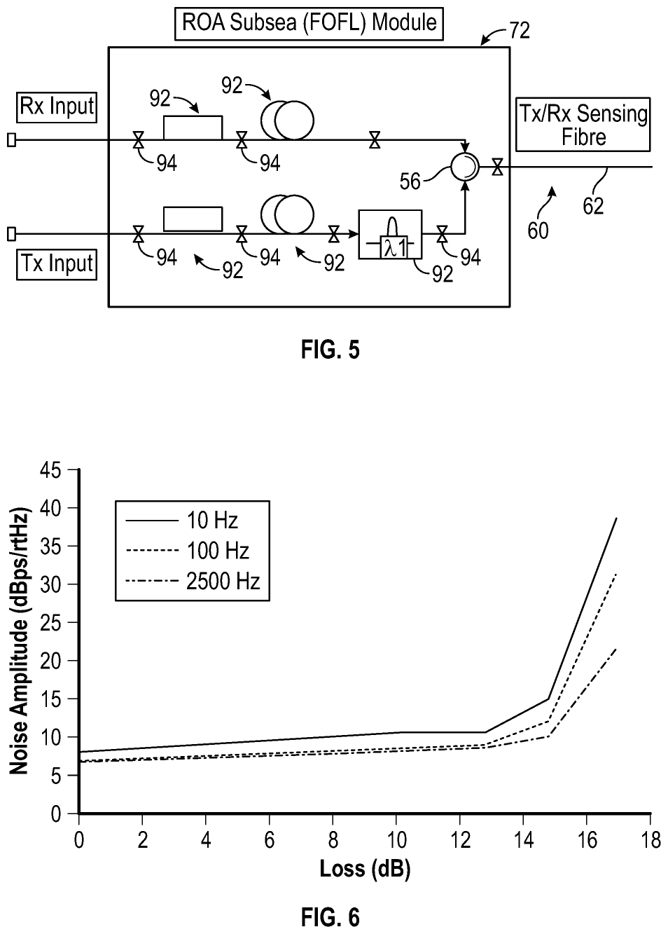

In some embodiments, the fiber optic flying lead 72 may support a plurality of channels meaning that distributed measurements can be made on a plurality of optical fibers in one well installation. The nature of this type of system is that outgoing pulses and returning backscatter are separated onto different optical fibers. This enables higher repetition rates which are limited simply by the length of the sensing fiber, e.g. distributed sensor 62. As such, the fiber optic flying lead 72 can have, for example, twice the number of inputs than outputs, as illustrated by the embodiment in FIG. 5. As further illustrated in FIG. 5, the fiber optic flying lead 72 may incorporate a variety of fiber-optic components and features in addition to the ROAs 58, including various filters 92 and splices 94 as are suitable to achieve a desired signal.

In FIG. 6, a graphical example is provided which shows the DAS noise levels as a function of increasing umbilical system loss. As described above, the distributed measurement system 34 enables a structure and technique which provide amplification of the output pulse and the optical backscatter to help overcome cumulative losses.

Depending on reservoir properties, production objectives, type of equipment employed, and/or other parameters of a given job, the number and type of components selected may vary. For example, the type of sensor system 60 may vary substantially depending on the desired parameters to be monitored. The length, sections, components, and features of umbilical 40 may change according to the specifics of a given job. Similarly, the components and features of the surface system 36 and subsea system 38 may be changed while still retaining the desired amplification to overcome losses.

Although a few embodiments of the disclosure have been described in detail above, those of ordinary skill in the art will readily appreciate that many modifications are possible without materially departing from the teachings of this disclosure. Accordingly, such modifications are intended to be included within the scope of this disclosure as defined in the claims. It is intended that the scope of the disclosure herein should not be limited by the particular embodiments described above.

What is claimed is:

1. A system for use in a subsea well related operation, comprising:
a distributed measurement system having a surface system coupled with a subsea system via an umbilical;
the surface system comprising a distributed interrogator and a surface circulator and pump module;
the subsea system having a remote circulator module, a distributed sensor being coupled with the subsea system; and
the umbilical comprising an outgoing optical fiber and a returning optical fiber.

2. The system as recited in claim 1, wherein the distributed sensor comprises a distributed acoustic sensor.

3. The system as recited in claim 1, wherein the surface circulator and pump module is configured to split an outgoing pulse and an incoming backscatter into the outgoing optical fiber and the returning optical fiber.

4. The system as recited in claim 1, wherein the surface system further comprises an optical switch.

5. The system as recited in claim 1, wherein the subsea system is at least partially in the form of a fiber optic flying lead.

6. The system as recited in claim 1, wherein the subsea system comprises a first remote optical amplifier.

7. The system as recited in claim 6, wherein the subsea system comprises a second remote optical amplifier.

8. The system as recited in claim 5, wherein the fiber optic flying lead comprises an integrated canister having space containing a plurality of remote optical amplifiers.

9. The system as recited in claim 5, wherein the fiber optic flying lead comprises a plurality of signal filters.

10. The system as recited in claim 1, wherein the subsea system comprises a remotely operated vehicle (ROV) panel.

11. A system, comprising:
a distributed acoustic sensor (DAS) system having a surface system coupled with a subsea system via an umbilical in a manner which reduces signal losses during measurement of a desired parameter;
the surface system comprising a distributed acoustic sensor interrogator, a surface pump module, and an optical switch connected to the umbilical; and
the subsea system comprising a fiber optic flying lead incorporating at least one remote optical amplifier.

12. The system as recited in claim 11, wherein the umbilical comprises a plurality of optical fibers.

13. The system as recited in claim 12, wherein the plurality of optical fibers comprises an outgoing optical fiber and a returning optical fiber.

14. The system as recited in claim 13, wherein the surface system processes a DAS pulse and a DAS backscatter.

15. The system as recited in claim 14, wherein the DAS backscatter comprises DAS backscatter returned uphole from the fiber optic flying lead via the returning optical fiber.

16. The system as recited in claim 11, wherein the fiber optic flying lead is coupled with a distributed acoustic sensor.

17. The system as recited in claim 16, wherein the fiber optic flying lead comprises a circulator and a plurality of remote optical amplifiers.

18. A method, comprising:
providing a distributed measurement system with a surface system coupled to a subsea system via an umbilical;
coupling a distributed sensor to the subsea system;
monitoring a parameter with the distributed sensor, and
utilizing an amplification technique in the subsea system to amplify an output optical pulse and an optical backscatter to thus help overcome cumulative losses along the umbilical.

19. The method as recited in claim 18, wherein coupling the distributed sensor comprises coupling a distributed acoustic sensor to the subsea system.

20. The method as recited in claim 18, wherein utilizing the amplification technique comprises employing a plurality of remote optical amplifiers in a fiber optic flying lead of the subsea system.
